(19) United States
(12) Patent Application Publication
(10) Pub. No.: US 2020/0103272 A1
(43) Pub. Date: Apr. 2, 2020

(54) ESTIMATION OF DRIFT IN A SOLAR RADIATION SENSOR

(71) Applicant: Commissariat à l'Energie Atomique et aux Energies Alternatives, Paris (FR)

(72) Inventors: Sylvain LESPINATS, Aix Les Bains (FR); Xavier LE PIVERT, Tresserve (FR)

(21) Appl. No.: 16/699,212

(22) Filed: Nov. 29, 2019

Related U.S. Application Data
(63) Continuation of application No. 14/401,176, filed on Nov. 14, 2014, now abandoned.

(30) Foreign Application Priority Data
May 14, 2012 (FR) 1254377

(51) Int. Cl. G01J 1/00; G01J 1/10

(52) U.S. Cl. CPC G01J 1/00; G01J 1/10

(57) ABSTRACT

The invention relates to a method for estimating drift in a solar radiation sensor (2) and for calibrating such a sensor, in which the radiation (G_{MES}) measured by this sensor under its conditions of use and a radiation model (51) are taken into account.

### FIELD

The present invention generally relates to solar radiation evaluation sensors, such as pyranometers or reference cells and, more specifically, to the drift estimation and the calibration of a sensor of this type.

### BACKGROUND

Solar radiation evaluation sensors are increasingly used as solar installations develop, be it for the generation of heat or of electrical power. Such sensors are used, in particular, to measure the radiation (Watt/m²) on the premises of solar power plants. Such measurements are used, among others, to estimate the solar resource or monitor the proper operation and the power generation of solar power plants.

Two categories of radiation sensors are essentially known: sensors formed of reference photovoltaic cells, and pyranometers, which are specific sensors dedicated to a measurement of the sky radiation (solar radiation). A pyranometer is a heat flow sensor which measures the received radiation.

All these radiation measurement devices deliver information (for example, a current, a voltage, or a digital word) representative of the radiation that they receive.

A recurring problem with the use of solar radiation sensors is that measurements drift along time. Such a drift imposes a regular recalibration.

Currently, to be recalibrated, sensors are generally dismounted and then sent back to the factory or to workshops to be submitted to a reference radiation and correct the coefficients of an algorithm applied to the measurements and delivering the real radiation from a raw measurement.

ISO standard 9847 describes devices of solar sensor calibration back in the workshop or by comparison with other sensors especially brought on the premises by a maintenance service. Such devices are not adapted to an on-site calibration or drift correction which is continuous over time and automated.

Documents U.S. Pat. Nos. 7,166,825, 7,576,346 and US 2009/0012731 describe radiation sensor recalibration systems mounted in spacecrafts. The described systems enable to calibrate the sensor by comparing the measurement performed on the concerned object (a given astral body) with a measurement performed on a reference object for which the radiation is accurately known (the sun, for example, which has a known radiation level, provided to be outside of the terrestrial atmosphere).

Such systems are not applicable to ground sensors, since the solar radiation can no longer be used as a reference due to the variability of the transmission of the radiation by the atmosphere according to the weather conditions.

As a consequence of the complexity of the recalibration of a radiation sensor, many new instruments are not recalibrated often enough (in practice, at most a few times a year), which adversely affects the accuracy of measurements and the estimation of the capacity of solar power plants. Further, the multiplication and the location of solar power plants (for example, in private homes) make such recalibrations more complex. Finally, cost considerations may result in neglecting this operation in certain cases.

Document EP-A-2211300 describes a method of forecasting the electric power production of a photovoltaic device and provides the diagnosis of a photovoltaic installation by comparing a real production with an estimated production. It is a measurement of the real electrical power production of the photovoltaic modules.

Article “Monitoring and remote failure detection of grid-connected PV systems based on satellite observations”, by A. Drews et al., Science Direct, Solar Energy 81 (2007), p. 548-564, describes a system of failure detection in photovoltaic panels, based on satellite observations, and which aims at avoiding the use of reference cells or of a pyranometer.

### SUMMARY

Thus, an embodiment of the present invention aims at providing a technique of estimating the drift of a radiation sensor which overcomes all or part of the disadvantages of known techniques.

Another object of an embodiment of the present invention is to provide a calibration technique adapted to an on-site operation.

Another object of an embodiment of the present invention is to provide a technique of drift estimation and calibration with no external intervention.

Another object of an embodiment of the present invention is to enable to increase the frequency of the calibrations of a radiation sensor.

Another object of an embodiment of the present invention is to provide a solution requiring no structural modification of the radiation sensor.

To achieve all or part of these and other objects, a method of estimating the drift of a solar radiation sensor is provided, wherein said sensor is a pyranometer or a reference cell associated with photovoltaic panels and wherein the radiation measured by the sensor in its conditions of use and a radiation model are taken into account.

According to an embodiment of the present invention, the model delivers an estimate of the radiation expected in the case of a clear sky.

According to an embodiment of the present invention, the model takes into account the geographic location of the sensor, the latter being located in the terrestrial atmosphere.

According to an embodiment of the present invention, a measured radiation is compared with the expected radiation, delivered by the model, during periods corresponding to a clear sky.

According to an embodiment of the present invention, an estimate of the sensor drift is calculated, preferably daily, taking into account prior estimates of the drift.

According to an embodiment of the present invention, instantaneous ratios between measured radiation values and values provided by the model, or between values given by the model and measured radiation values, are used.

According to an embodiment of the present invention, an instantaneous ratio is taken into account if the time is comprised within a time range during which the ratio variation is smaller than a threshold.

According to an embodiment of the present invention, a ratio is taken into account if its value is comprised between two thresholds.

According to an embodiment of the present invention, a ratio is taken into account if it corresponds to a daytime period.

According to an embodiment of the present invention, the estimate of the drift is obtained from a weighted average of estimates calculated during the previous days.

According to an embodiment of the present invention, the weighting takes into account the distance in past of the days taken into account.

According to an embodiment of the present invention, the weighting takes into account a reliability coefficient assigned to the estimate of the considered day.

According to an embodiment of the present invention, the weighting takes into account the value of the estimate.

A method of calibrating of a solar radiation sensor is also provided, wherein a correction coefficient to be applied to the measurements is obtained from an estimation of the sensor drift according to the above method.

A solar radiation sensor capable of implementing the calibration method is also provided.

A solar power plant equipped with such a solar radiation sensor is also provided.

### BRIEF DESCRIPTION OF THE DRAWINGS

The foregoing and other features and advantages will be discussed in detail in the following non-limiting description of specific embodiments in connection with the accompanying drawings, among which:

FIG. 1 very schematically illustrates an example of a system for estimating the solar power generation capacity at the scale of a territory;

FIGS. 2A and 2B are arbitrary examples of curves of the solar radiation received by a radiation sensor;

FIG. 3 is a block diagram illustrating steps of an embodiment of the radiation sensor calibration method; and

FIGS. 4A and 4B illustrate the operation of the embodiment of FIG. 3.

### DETAILED DESCRIPTION OF THE PRESENT EMBODIMENTS

The same elements have been designated with the same reference numerals in the different drawings. For clarity, only those steps and elements which are useful to the understanding of the described embodiments have been detailed. In particular, what use is made of the radiation sensor measurements to estimate the power generation capacity of a power plant has not been detailed, the described embodiments being compatible with the current use of measurements delivered by a solar radiation sensor. Further, the practical forming of a radiation sensor and the conversion of the measurement signal have not been detailed either, the described embodiments being, here again, compatible with usual radiation sensors equipped with calculation means.

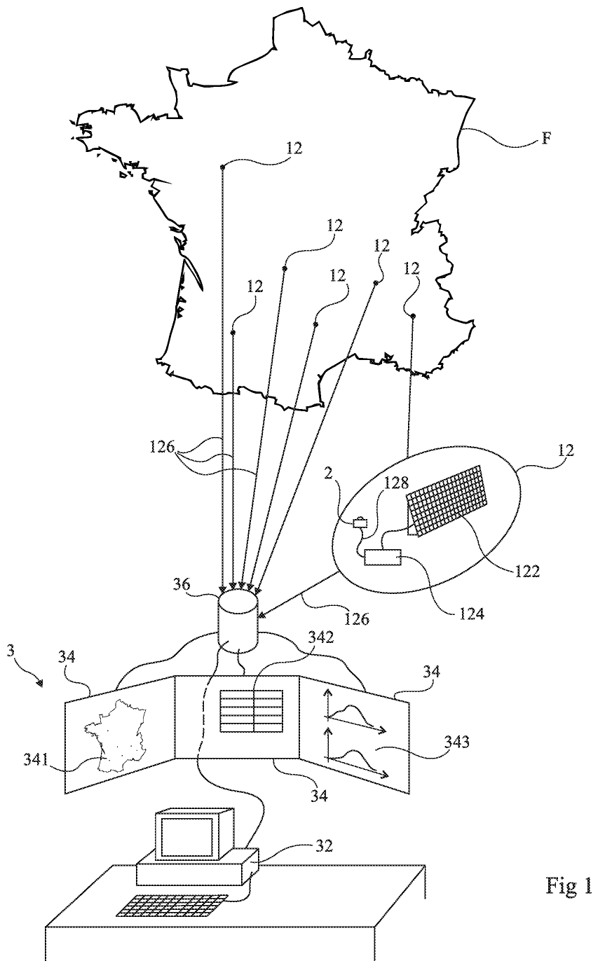

FIG. 1 illustrates an example of a plant for harnessing solar power in centralized fashion for power distribution management purposes.

Multiple solar power plants 12, each formed of one or of a plurality of assemblies of photovoltaic panels (solar panels) 122, and of a power management and conversion system 124 (especially including an inverter) are distributed over a territory F. System 124 is generally associated with a radiation sensor 2 (for example, of pyranometer type). This sensor measures the radiation in the terrestrial atmosphere.

The power delivered by each plant 12 may for example be injected into the electrical power distribution network of territory F and, in parallel, the various power plants 12 send data (connections 126) to a computer system 3 centralizing the power management. System 3 generally comprises a network control and operating room, equipped with one or a plurality of computers 32, with one or a plurality of screens 34, and with one or a plurality of databases 36 receiving the information from the different power plants.

System 3 enables one or a plurality of operators to manage the power distribution from the information, known beforehand or collected from the different power plants, that they view on the screens. This information includes, among others, the geographic location of the power plants (map 341), information 342 relative to the production and the demand and, for example, information relative to radiation 343 received by one or a plurality of power plants, allowing a comparison with an expected production.

The representation of FIG. 1 is an illustrative example of a possible application of the embodiments which will be described. This illustration is of course simplified, since the described embodiments do not bear on the use of the measurements obtained by the solar radiation sensors to predict a power generation capacity or manage the distribution. The utilization of the generation capacities uses current techniques, most often independent from the nature of the power source.

A specificity of solar power generation however is the need to forecast, particularly based on the weather conditions, the generation capacity of solar power plants with respect to other power sources. Another specificity is the dissemination of power plants having a low generation capacity (less than 10 kW) over the totality of a territory.

As a result of such specificities, the reliability of the radiation measurements performed at the level of the actual power plants is particularly important.

Further, the dissemination and the large number of solar power plants make it more difficult to return the pyranometers or other sensors to the workshop for a recalibration.

It could be envisaged to use portable calibration devices and to periodically organize maintenance visits in the different power plants. This however considerably increases the cost of the calibration and accordingly the power generation cost. It is further not conceivable to frequently visit small-capacity power plants, which accordingly delays the taking into account of possible drifts.

In the context of the follow-up of a group of solar power generation plants, production forecasts may be made for the near future. Most systems are based, in this case, on field measurement to feed artificial intelligence procedures. The solar radiation measurements are of course taken into account. Accordingly, the presence of aberrant measurements due to the poor calibration of the sensors considerably handicaps the forecast performance. There thus is a real need for a sensor drift estimation and correction, all the more if the system operates homogeneously on all the power plants. Of course, other applications can be envisaged, such as for example, the monitoring of the “performance ratio” of photovoltaic power plants, weather forecasting, etc.

The calibration of a radiation sensor, initially or in operation, comprises determining coefficients of an affine function applied to the measured values. This function corrects the measurements and delivers a radiation value. Noting G_{MES} the performed measurement and G_{COR} the corrected measurement, at a given time t, the corrected measurement is obtained by applying a relation of the following type:

G_{COR}(t)=α·(G_{MES}(t)−β), (1)

where α and β are coefficients of the affine function determined for the sensor calibration.

In practice, the drift of coefficient β is negligible and only the drift of coefficient α over time is considered herein.

A method of evaluating the performance of a plurality of interconnected photovoltaic modules has already been provided, for example, in article “An evaluation method of PV systems” by T. Oozeki, T. Izawa, K. Otani, and K. Kurokawa (Solar Energy Materials & Solar Cells 75 (2003) 687-695). This method evaluates the powers generally generated by the power plant in a month. It is then searched for the minimum coefficient by which the so-called clear-sky radiation, that is, the radiation in the absence of clouds, should be multiplied to include the measurements performed by the sensor. Such an adaptation is not performed in real time and requires measurements over several days. This enables to define a sort of “effective peak power” of the power plant, but this implies no estimation of the received radiation.

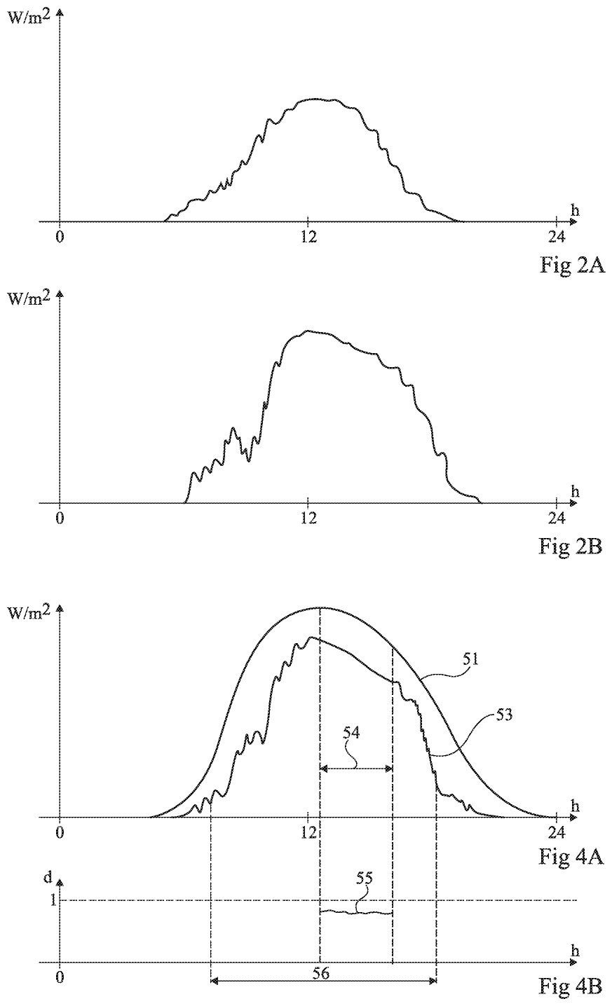

FIGS. 2A and 2B illustrate two examples of radiation curves (Watt/m2) obtained over time (h) all along one day by a solar sensor. Such radiation measurements should be usable to then estimate the power generation capacity of a solar power plant. During a normal day, that is, with no radiation variations other than those due to the sun's path, and thus to the time of the day, the curve approximately follows a bell curve. In practice, there always are disturbances (clouds, objects, fouling (bird droppings), etc.) temporarily forming a shield between the sensor and the sky. FIG. 2A illustrates the case where minor disturbances appear. FIG. 2B illustrates the case where, for a few hours, the sensor is partially shaded, sufficiently however to significantly decrease the received radiation.

The calibration method provided hereafter is based on an estimate of the sensor drift using periods during which the sensor is in a clear sky condition (no clouds).

A radiation model providing a theoretical curve of the radiation, in a clear sky condition, for the area where the sensor and the solar power plant are positioned, is then used. Such a theoretical curve may take into account other parameters such as the date, the inclination, and the orientation of the sensor.

The value of correction coefficient c (which also rep-resents an estimate of the drift) to be applied to the measurements is adapted, for the current day, according to a processing of the measurements of one or, preferably, of a plurality of previous days.

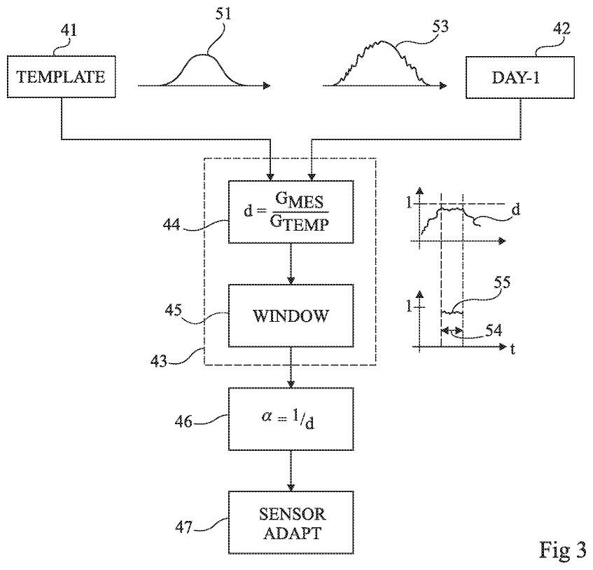

FIG. 3 is a block diagram illustrating steps of an embodiment of the solar radiation sensor calibration method.

FIGS. 4A and 4B are timing diagrams illustrating the operation of this method.

The method is implemented by a digital processing circuit of microprocessor type, programmed to implement the different steps which will be described. Digital processing circuits and memories usually fitting either the radiation sensor 2 itself, or a possible management device (124, FIG. 1) which receives the information from radiation sensor 2, or more generally any computer device capable of communicating with the sensor, are used.

) A daily model 51 of clear sky radiation of the area where the sensor is placed is stored (block 41, TEMPLATE) in the processing device. This storage is for example performed during the installation of the solar power plant and of the sensor. As a variation, the model is calculated on the fly, which enables to more easily take into account parameters other than the location (date, inclination, orientation, etc.).

Theoretical models enabling to estimate the clear sky radiation on a given region according to the date, to the time, to the longitude, to the latitude, to the orientation of the panel or of the sensor, to the inclination, to the albedo, etc. are known. It is assumed that the model of block 41 takes into account all or part of these parameters and, preferably, all.

Such models are for example described in article “On the clear sky model of ESRA—European Solar Radiation Atlas—with respect to the Heliosat method” by C. Rigollier, O. Bauer, and L. Wald, published in Solar Energy Vol. 68, No. 1, pages 33-48, in 2000.

Such models provide, according to the date of the year, a bell shape 51 (FIG. 4A) indicating the radiation in Watt/m² according to the hour (h) of the day. At night, the radiation is almost zero.

To estimate the drift and determine coefficient α to be applied to the measurements so that, in case of a clear sky, the measured radiation corresponds to the radiation of the model, it is desired to determine, during a day of real measurements performed by the sensor, periods where the latter was in a clear sky situation.

To achieve this, the model being established on a daily cycle, the curve of the radiation measured by the sensor during a day is stored (curve 53, FIG. 4A). In practice, to optimize the control of the sensor calibration, the measurements of the day preceding the calibration time are stored (block 42, DAY 1). It can be considered that at midnight (24 h), the full daily cycle of the elapsed day is available. The processing which will follow applies to the data of this elapsed day.

A comparison (block 43) of the real obtained curve 53 with clear sky model 51 is then performed. This comparison aims at determining one or a plurality of time windows or ranges 54 during which real curve 53 can be considered as corresponding to a clear sky exposure.

In practice, the comparison is performed on digital values since the sensor generally delivers discrete values over time (it delivers one value at each measurement). The comparison is preferably performed over all the measurements taken by the sensor, which improves the reliability of the result or, as a variation in order to spare computing resources or consume less, over only one measurement out of a predefined number of measurements (for example, one measurement out of two, one measurement out of four, etc.). A plurality of consecutive measurements which are aggregated (by their average, their median, etc.) may also be provided. The choice of the number of measurements taken into account depends, among others, on the sensor measurement frequency. If it takes a very large number of measurements (for example, every second or several per second), it is possible not to take all measurements into account without losing too much information. If, however, the frequency of the measurements is lower (for example, every minute), it is preferably to take all the measurements into account for the calibration.

For each measurement (sample), it is desired to determine whether the measurement corresponds to a clear sky instant (that is, to a moment when the sun is not masked). To achieve this, an instant when the curve of the measurements normalized to the theoretical clear sky curve is relatively smooth (with a variation threshold of the standard deviation over a sliding window) over a sufficient time interval around the considered time may be retained as corresponding to a clear sky instant.

The inventors have observed that the interval between the real radiation in a clear sky period and a model of this radiation directly provides an at least approximate value of coefficient α of the correction to be applied to the sensor for the calibration thereof.

Actually, considering clear sky periods, that is, periods during which the sensor should give values corresponding to those of the model, the above correction formula (1) should provide the value of the model from the measured value. Neglecting coefficient β which is, in practice, close to 0 and thus all the more negligible as the radiation is strong (case of a clear sky), it can be seen that the correction to be applied amounts to the ratio of the value given by the model to the measured value.

Thus, the ratio of the measured instantaneous value, G_{MES}, to the instantaneous value, G_{TEMP}, provided by the template is evaluated (block 44, d=G_{MES}/G_{TEMP}). This positive quantity d is all the smaller as the sky is overcast and is theoretically equal to one if the sensor is perfectly calibrated and the sky is clear. FIG. 4B illustrates curve 55 obtained on time window 54. This curve gives an indication of the defect of coefficient α (actually, of the inverse thereof).

As a variation, inverse ratio 1/d, that is, ratio G_{TEMP}/G_{MES} which directly provides the value of coefficient α, may be evaluated. Whatever the ratio used, this ratio represents an estimate of the sensor drift.

To avoid the taking into account non-significant periods (for example, at night, when the radiation is in principle close to 0) or strong variations (dawn and dusk), the determination of the clear sky time window (block 45, WINDOW) is performed within a so-called daytime period 56. Such a daytime period is arbitrarily selected, as an example, as corresponding to a period where the radiation according to the clear sky model is greater than a given value, typically 50 Watt/m². It is generally considered that the periods where the radiation is in the range from 0 to 50 Watt/m² correspond to dawn and to dusk. The absolute 50 Watt/m² threshold is of course adapted according to locations. As a variation, the selection of the daytime period may be performed based on a calendar and on an indication of the hour.

In the case where a plurality of time windows are considered, an average of the values obtained over the different periods is for example calculated.

The calibration is preferably performed during the second part of the night, that is, between midnight and the dawn of the next day. The simplicity of the determination enables to perform a daily calibration. If no acceptable time window is available in a given day, the calibration is postponed to the next day.

The reliability of the correction of the sensor calibration depends, among others, on the determination of clear sky moments. The more efficient the detection of clear sky moments (that is, the more false positives and false negatives will be set aside), the better the determination of coefficient α.

To detect clear sky periods, it is possible to look for the time windows for which ratio d (between the measurements and the theoretical model) exhibits relatively small variations and a sufficient level. For example, if ratio d, on the time window around a given time (for example, 1 hour before and 1 hour after the selected time), has a standard deviation smaller than a threshold value and belongs to an interval considered as reasonable, the selected instant may be considered as an instant when the sky is clear. The range of more or less one hour is an example which may be modified.

The inventors have observed that the selection of the width of the time window may be modified by taking into account (among others) the sampling of the considered data. The shorter the time interval between two measurements, the more the size of the window can be decreased. If no acceptable time window is available in a given day, the calibration is postponed to the next day.

The calculations on time windows enabling the detection of clear sky times are performed iteratively on each of the samples. Such an iterative determination is particularly adapted to software-driven digital processing systems.

According to a simplified embodiment, it is considered that the estimation of coefficient α for the considered day, which represents the correction value to be applied to the affine function of the sensor, corresponds to the inverse of the median value of the coefficients d present in the time window(s) (block 46, α=1/d). The sensor adaptation (block 47, SENSOR ADAPT) is performed from the obtained coefficient α.

In practice, the estimation of coefficient α varies from one day to the other, be it due to a drift in the sensor operation, such a drift being progressive, due to a small quantity of clear sky moments during the day, or due to inaccuracies in the detection of clear sky periods (for example, cloudy periods, which are stable all throughout a day).

Thus, a weighting of a plurality of determinations of coefficient α according to one or a plurality of factors is preferably performed.

Preferably, the importance given to the different factors is itself weighted. As an example, the inventors consider that the distance in past of the day is the most significant factor, the reliability of the day coming second, and the absolute level of the day being the least significant.

Other weightings may be envisaged to make the determination still more reliable. For example, the delay between the current day and the average of the previous days may be taken into account.

Taking the example of the distance in past of the day, of the reliability of the day, and of the absolute level of the day, the following factors may for example be used.

A factor takes into account a weighted average of the coefficients of the previous days by assigning to the coefficient of a given day a weight which is all the smaller as this day is distant in the past from the current day.

Another factor takes into account the estimated reliability of the considered day. This reliability corresponds to the number of ratios d taken into account on the considered day, which amounts to classifying the days, or coefficients α, according to the number of clear sky periods on which the value is based. The larger this number, the more the weight given to the considered coefficient α is significant.

Still another factor is the obtained radiation level. This amounts to stressing the days in which the values calculated for ratio d are the highest.

The determination of the weight to be assigned to coefficients α of the different days by taking into account the above variations amounts to calculating the product of the factors for each day. The weights are obtained by normalizing the results so that the sum of the weights is equal to 1. In practice, it may be decided to only consider a number of the days corresponding to the most recent ones.

In practice, the above steps are carried out by successively processing the samples of the considered day. The processing can be expressed as follows.

Note i the time or the rank of the sample in the day, and j the day (j=0 for the current day, that is, the day at the beginning of which the evaluation based on the performed measurements is calculated, j=1 for the day when the measurements are performed, that is, the day before the current day, j=2 for the previous day, etc.).

A time slot (in number of samples) around the current sample defining an interval (time range) during which the measurement should be approximately stable to consider that there is no disturbance (cloud or other), is designated as x. A threshold y of ratio d(i) below which the standard deviation of the ratio calculated on the time slot should remain so that the radiation is considered as having remained “stable” is determined.

A threshold z of determination of too dark or aberrant measurements is set. For example, if d(i) is smaller than 1 z, the sky is considered as “dark” at time i, if d(i) is greater than 1+z, the sky is considered as “abnormally clear” at time i (outlier). After a long drift period, a sensor may return values outside of interval [1−z, 1+z]. It is however possible to be protected against an inappropriate elimination of these values by normalizing values G_{MES} based on the estimate of coefficient α of the day before. In this case, once the verification has been performed, the inverse operation will be carried out to avoid disturbing the rest of the calculation.

A ratio d(i) is taken into account for the calculation of the median (taken into account in curve 55) if:
the time slot from i x to i+x is comprised within the “day”, that is, either measurement G_{MES} is greater than a threshold (for example, 50 Watt/m2) in this entire range, or the range excludes the night, dawn and dusk, or both;
the standard deviation of ratios d(i) in the range from i x to i+x is smaller than threshold y (for example, the standard deviation threshold is selected to be in the range from 0.03 to 0.1, typically in the order of 0.06); and
the value of ratio d(i) is in the range from 1 z to 1+z (for example, threshold z is in the range from 0.2 to 0.6, preferably in the order of 0.4).

Coefficient α0 is obtained according to the following relation:

$${α}_{0} = \frac{{\sum }_{j = 1}^{N} ( {p}_{j} \cdot {α}_{j} )}{{\sum }_{j = 1}^{N} {p}_{j}} , \qquad ( 2 )$$

where N represents the number of past days taken into account (preferably from 10 to 30) and pⱼ represents the weight assigned to the day of rank j. It thus is an average weighted by coefficients αⱼ.

In a simplified embodiment, only the distance in past of the day is taken into account. For example, weights pⱼ corresponding to the rank of the day (pⱼ=j) are assigned.

In a preferred embodiment where the three above-mentioned factors are taken into account, weight pⱼ is obtained, by combining weights pⱼ^{t}, pⱼ^{d}, and pⱼ^{e} respectively given to the distance in past of coefficient αⱼ, to the number of data on which coefficient αⱼ is based, and to the value of coefficient αj according to the following relation:

$$\begin{matrix}{p}_{j} = \frac{{p}_{j}^{t} \cdot {p}_{j}^{d} \cdot {p}_{j}^{e}}{{\sum }_{j = 1}^{N} ( {p}_{j}^{t} \cdot {p}_{j}^{d} \cdot {p}_{j}^{e} )} , with \text{:} & ( 3 ) \\ {p}_{j}^{t} = exp ( - 10 \cdot \frac{{n}_{j}^{t}}{N} ) ; & ( 4 ) \\ {p}_{j}^{d} = exp ( - 7 \cdot \frac{{n}_{j}^{d}}{N} ) ; and & ( 5 ) \\ {p}_{j}^{e} = exp ( - 4 \cdot \frac{{n}_{j}^{e}}{N} ) , & ( 6 )\end{matrix}$$

where:

nⱼ^{t} designates the number of estimate αⱼ classified from the most recent to the oldest (for example, 1 for α₁, 2 for α₂, up to N for α_{N});

nⱼ^{d} designates the number of estimate αⱼ classified according to the number of d(i) taken into account for the calculation thereof (1 for the value of αⱼ based on the greatest number of times i considered as “clear sky” moments on day j, N for the value of αⱼ based on the smallest number of times); and

nⱼ^{d} designates the number of estimate αⱼ classified according to the level of value αⱼ (1 for the greatest, N for the smallest).

Numbers 10, 7, and 4 of formulas (4) to (6) are examples of importance factors given to weights pⱼ^{t}, pⱼ^{d}, and pⱼ^{e}. The higher the number forming the factor of the exponential function, the more significant the weight in the average of formula (3).

The sum of weights pj is normalized to 1 (the average being calculated by formula (3)). Accordingly, formula (2) becomes:

$${α}_{0} = {\sum }_{j = 1}^{N} ( {p}_{j} \cdot {α}_{j} ) , \qquad ( {2}^{′} )$$

An advantage of the described embodiments is that it is now particularly simple to calibrate a sensor in real time according to the drifts to which it is submitted. This considerably reliabilizes solar radiation measurements.

Another advantage of the described embodiments is that their implementation requires no structural modification of existing solar radiation sensors, the estimation of the drift and the subsequent calibration being performed based on an interpretation of the measured and stored values. It should be noted that the estimation of the sensor drift, or the determination of correction value α, may even be performed at a distance from the sensor, in solar panel management device 124, or even on a distant server.

Various embodiments have been described. Various alterations and modifications will occur to those skilled in the art. In particular, everything that has been discussed in relation with a direct measurement of the radiation may be performed based on variables representative of this radiation. For example, it may be the current flowing through the sensor measurement element or any other variable representative of the instantaneous radiation. Further, the practical implementation of the described embodiments is within the abilities of those skilled in the art based on the functional indications given hereabove by using computer and programming tools.

What is claimed is:

1. A method for operating a solar radiation sensor, wherein said sensor is a pyranometer or a reference cell associated with photovoltaic panels, the method comprising:
calculating an estimate of drift of the solar radiation sensor according to at least one ratio of at least one radiation measurement (G_{MES}) by the solar radiation sensor in its conditions of use to at least one correspondingly time-aligned value of a radiation model, or vice versa;
calculating a correction factor based on the estimate of drift of the solar radiation sensor; and
operating the solar radiation sensor based on the correction factor.

2. The method of claim 1, wherein the model delivers an estimate of the radiation expected in the case of a clear sky.

3. The method of claim 1, wherein the model takes into account the geographic location of the sensor, the latter being located in the terrestrial atmosphere.

4. The method of claim 1, wherein the ratio of the at least one radiation measurement (G_{MES}) to the at least one value of the radiation model, or vice versa, is determined during periods corresponding to a clear sky.

5. The method of claim 1, wherein the estimate of drift of the solar radiation sensor is calculated taking into account prior estimates of the drift.

6. The method of claim 1, wherein the at least one ratio is taken into account if a time corresponding to the at least one radiation measurement and the at least one value of the radiation model is within a time range during which a variation of the ratio is smaller than a threshold.

7. The method of claim 1, wherein the at least one ratio is taken into account if its value is between two thresholds.

8. The method of claim 1, wherein the at least one ratio is taken into account if a time corresponding to the at least one radiation measurement and the at least one value of the radiation model is within a daytime period.

9. The method of claim 1, wherein the estimate of the drift is obtained from a weighted average of estimates calculated during the previous days.

10. The method of claim 9, wherein the weighting takes into account the distance in past of the days taken into account.

11. The method of claim 9, wherein the weighting takes into account a reliability coefficient assigned to the estimate of the considered day.

12. The method of claim 9, wherein the weighting takes into account the value of the estimate.

13. A solar radiation sensor comprising a digital processing circuit programmed to implement the method of claim 1.

14. A solar power plant equipped with the solar radiation sensor of claim 13.
